(19) United States
(12) Patent Application Publication
(10) Pub. No.: US 2012/0260049 A1
(43) Pub. Date: Oct. 11, 2012

(54) CLONING METHOD AND SYSTEM

(75) Inventors: WILLIAM WEIHAN YAO, Irvine, CA (US); RAYMOND PATRICK MCGOLDRICK, Laguna Hills, CA (US); HIROSHI NISHIMURA, Irvine, CA (US); SANFORD TANG, Cerritos, CA (US)

(73) Assignee: NTI CORPORATION, Irvine, CA (US)

(21) Appl. No.: 13/082,629

(22) Filed: Apr. 8, 2011

(51) Int. Cl. G06F 12/16

(52) U.S. Cl. 711/162; 711/E12.103

(57) ABSTRACT

The invention is directed to a method and a system for cloning a source drive to a target drive. A cloning program launches in a host device, and an amount of partitions and a size of each said partition of the source drive are obtained. The size of each corresponding partition in the target drive is adaptively determined according to a size of the source drive and a size of the target drive. The host device is rebooted and contents of the source drive are copied to the target drive.

### BACKGROUND OF THE INVENTION

1. Field of the Invention

The present invention generally relates to drive cloning, and more particularly to a method and system of cloning the source drive to the target drive with the partitions being adaptively resized.

2. Description of Related Art

Drive cloning (or disk cloning) is a process of copying the contents of a hard disk drive (HDD) of a computer to another disk drive, which may be another HDD or a solid state drive (SSD). The drive cloning has many usages. For example, a user may use the drive cloning to upgrade the HDD to a faster drive such as SSD. The drive cloning may be used instead to create a backup of the HDD in the computer, and the backup may later be used to recover the computer.

Conventional drive cloning software is usually not user-friendly, and generally needs a lot of user interaction which might cause confusion for the user. For example, in order to begin the cloning, the user should first open a boot menu, for example, by pressing a function key, and then select a boot device from the boot menu.

Furthermore, the conventional drive cloning software performs the drive cloning by duplicating not only the contents of the source drive, but also replicating the partition information such as the partition size of the source drive. As a destination drive may commonly have a size different from the source drive, the drive cloning therefore cannot be performed effectively. For example, space is wasted on the destination drive if the destination drive has a size substantially greater than the source drive; or the contents to be cloned cannot be entirely cloned to the destination drive if the destination drive has a size substantially smaller than the source drive.

Although the conventional drive cloning software may have provided some means for the user to manually set the size of each partition, such means, however, normally creates confusion rather than convenience for an average user being not acquainted with related acknowledge.

For the reason that conventional drive cloning software could not provide the user with convenience and facilitation, a need has arisen to propose an unsophisticated novel scheme for cloning a drive for the average user.

### SUMMARY OF THE INVENTION

In view of the foregoing, it is an object of embodiments of the present invention to provide a method and system for cloning a source drive to a target drive with partitions being dynamically and automatically resized.

According to one embodiment, a cloning program launches in a host device, and an amount of partitions and a size of each said partition of the source drive are obtained. The size of each corresponding partition in the target drive is adaptively determined according to a size of the source drive and a size of the target drive. After rebooting the host device, contents of the source drive are copied to the target drive. In one embodiment, at least one of the partitions of the target drive has a size greater than the corresponding partition of the source drive when the size of the target drive is greater than the size of the source drive; and at least one of the partitions of the target drive has a size smaller than the corresponding partition of the source drive when the size of the target drive is smaller than the size of the source drive.

### BRIEF DESCRIPTION OF THE DRAWINGS

FIG. 1 shows a block diagram illustrating a cloning system for cloning a source drive to a target drive according to one embodiment of the present invention;

FIG. 2 shows a flow diagram illustrative of a cloning method for cloning the source drive to the target drive according to one embodiment of the present invention;

FIG. 3A to FIG. 3C show exemplary graphical user interface (GUI) display images during the cloning process; and

FIG. 4 shows exemplary partitions of the source drive and the adaptively determined partitions of the target drive according to one embodiment of the present invention.

### DETAILED DESCRIPTION OF THE INVENTION

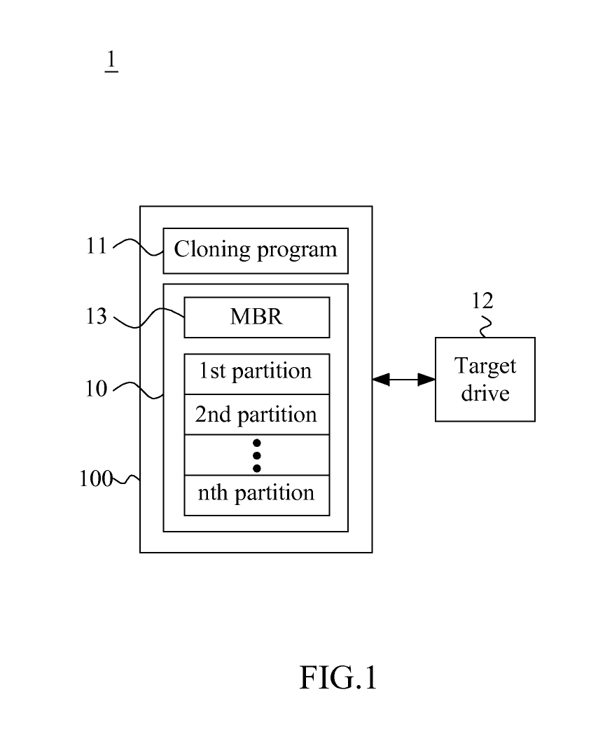

FIG. 1 shows a block diagram illustrating a cloning system 1 for cloning a source drive 10 to a target drive 12 according to one embodiment of the present invention. In the embodiment, the source drive 10 may be, but is not limited to, a hard disk drive

(HDD) in a computer 100, and the target drive 12 may be, but is not limited to, a solid state drive (SSD), a Universal Serial Bus (USB) drive or a USB flash drive. The cloning system 1 of the embodiment may, but not exclusively, be utilized to upgrade the source drive 10 to the target drive 12. In another embodiment, the cloning system 1 may be utilized, for example, to restore a computer to its original configuration or to create a comprehensive backup of an operating system (OS) and installed software of a computer.

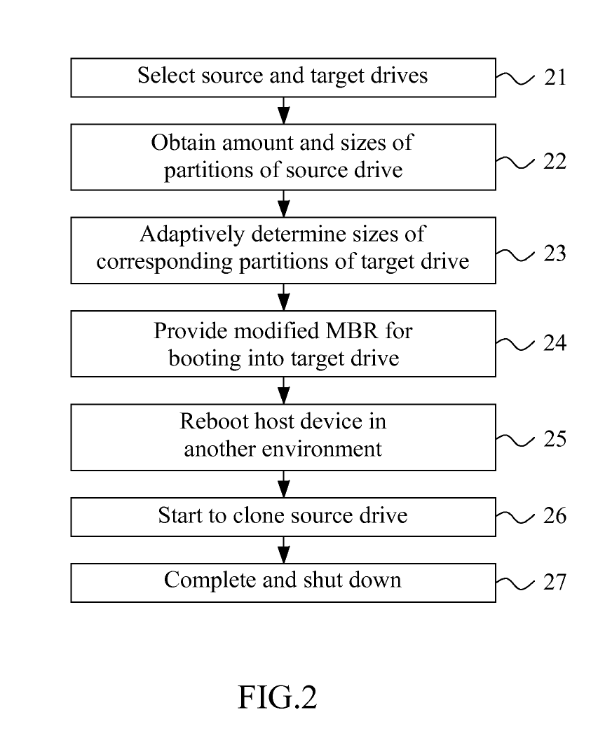

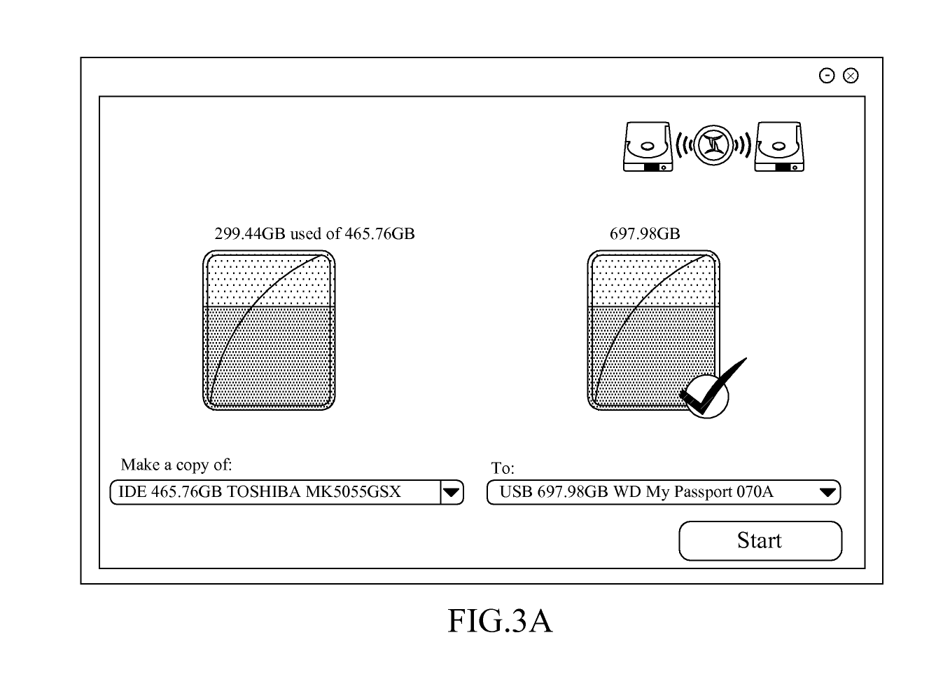

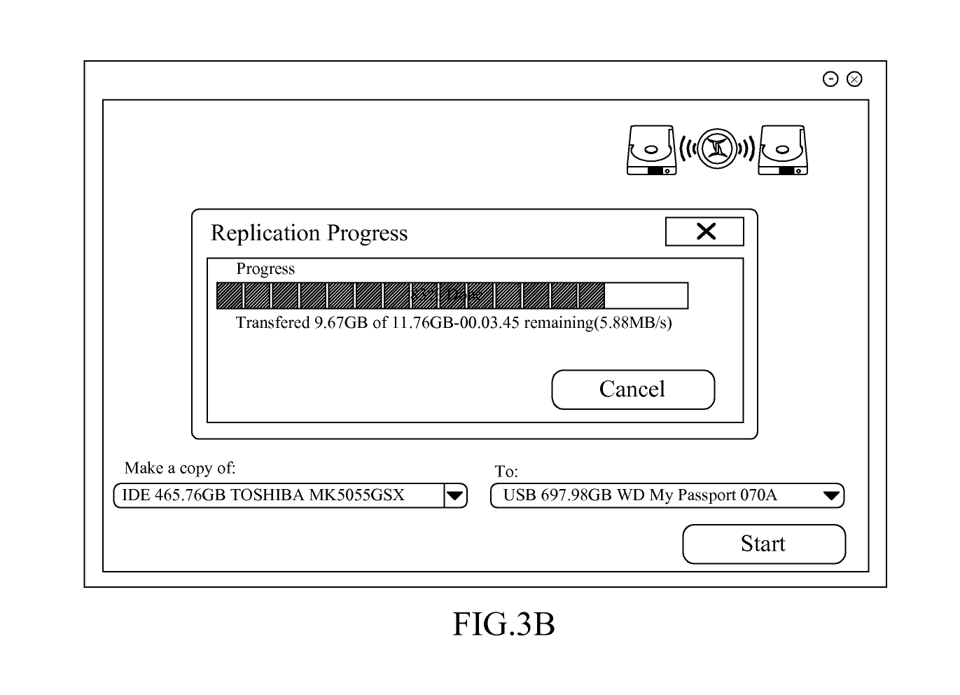

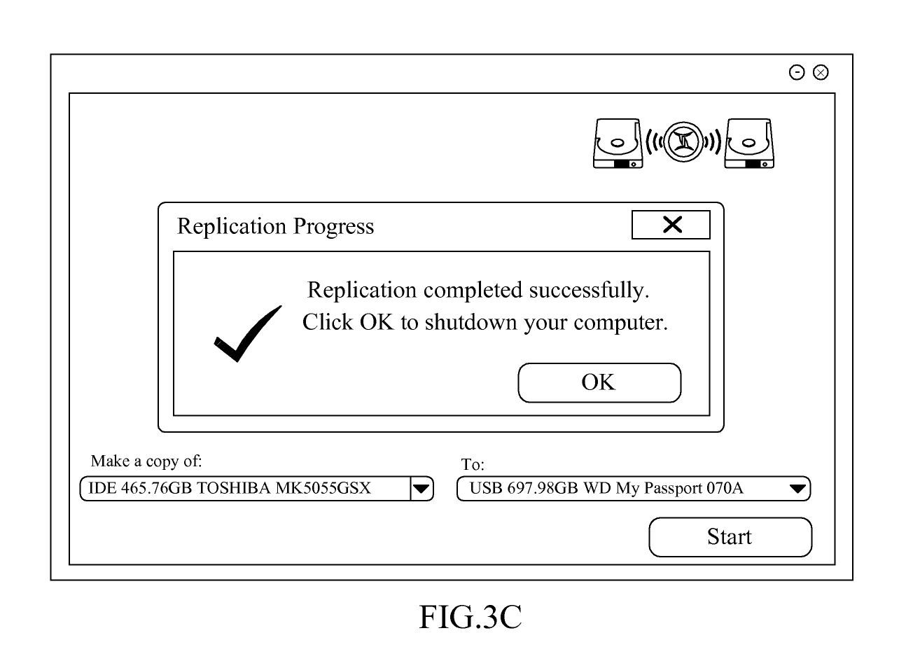

FIG. 2 shows a flow diagram illustrative of a cloning method for cloning the source drive 10 to the target drive 12 according to one embodiment of the present invention. In step 21, a cloning program 11 is installed in the computer 100. When the cloning program 11 is launched, a user interface such as the graphical user interface (GUI) exemplified in FIG. 3A allows a user to select a source drive and a target drive, or to accept the default source/target drives. After the user clicks a Start button, the cloning process begins.

Subsequently, in step 22, the amount of partitions and the size of each partition in the source drive 10 are obtained, for example, according to a Master Boot Record (MBR) 13. The MBR 13 is the first sector (or boot sector) of the first cylinder in the source drive 10. The MBR 13 contains, among other things, a partition table (or partition record) that records the start address and end address of each partition. Based on the partition information obtained from step 22, the size of each corresponding partition in the target drive 12 is adaptively determined (step 23). In the embodiment, the partitions of the target drive 12 are adaptively determined to match the size of the target drive 12 by taking into consideration both the size of the source drive 10 and the size of the target drive 12. For example, in the case that the target drive 12 has a size (e.g., 500 GB) greater than the size (e.g., 250 GB) of the source drive 10, one or more partitions of the target drive 12 should have a partition size greater than the corresponding partition of the source drive 10. Taking an opposite example, in the case that the target drive 12 has a size (e.g., 150 GB) smaller than the size (e.g., 250 GB) of the source drive 10, one or more partitions of the target drive 12 should have a partition size smaller than the corresponding partition of the source drive 10. In other words, the partition(s) are grown to match a larger target drive 12, and are shrunk to match a smaller target drive 12. The growing or shrinking ratio is commonly determined according to the size of the source drive 10, the size of the target drive 12 and the amount of partitions.

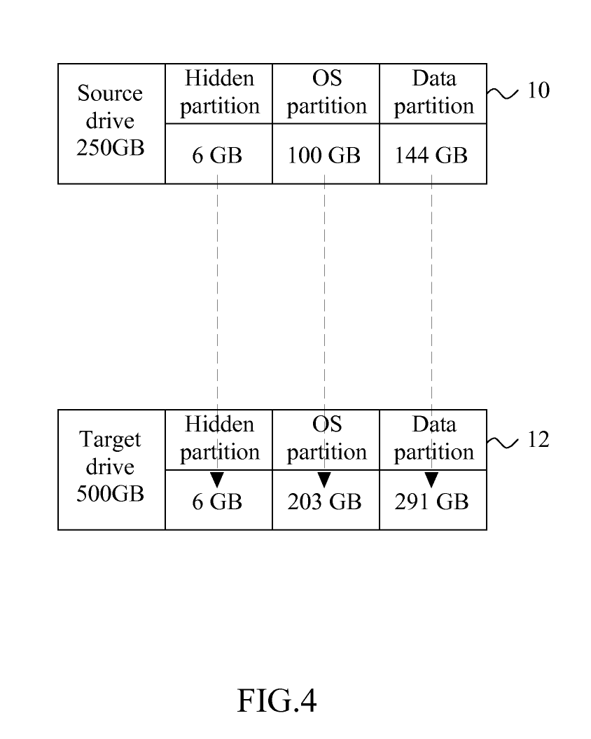

FIG. 4 shows exemplary partitions of the source drive 10 and the adaptively determined partitions of the target drive 12 according to the embodiment of the present invention. In this example, the source drive 10 has a size of 250 GB and the target drive 12 has the size of 500 GB. The source drive 10 has three partitions: hidden partition, OS partition and data partition, which have the sizes of 6 GB, 100 GB and 144 GB respectively. In the target drive 12, the corresponding hidden partition retains the same size, while the corresponding OS partition and the data partition are increased to 203 GB and 291 GB, respectively.

Afterwards, in step 24, a modified MBR for booting into the target drive 12 is provided according to the sizes of the partitions determined in step 23. Subsequently, in step 25, the computer 100 is rebooted into another environment such as Linux compliant with the target drive 12, and, in step 26, the contents of the source drive 10 are copied (or cloned) to the target drive. FIG. 3B shows an exemplary user interface showing progress of the cloning process. For example, a progress bar displays in real-time the amount of data being transferred from the total size (e.g., in GB), the estimated time remained and the speed of the data transferring (in MB/s). When the cloning process has been completed, as shown in FIG. 3C, the user is notified of the completion and is prompted to shut down the computer 100 (step 27). Accordingly, the source drive 10 is upgraded to the target drive 12.

According to embodiments discussed above, the cloning process (i.e., steps 21 through 27) dynamically resizes the source drive 10 to fit into the target drive 12. For a larger target drive 12, the cloning process will dynamically grow the partitions proportionately to use all the available space on the target drive 12. For a smaller target drive 12, the cloning process will dynamically shrink the partitions proportionately to fit onto the smaller target drive 12. In the embodiment, the cloning process (i.e., steps 21-27) automatically performs without the user's intervention. That is, the user simply presses the start button (FIG. 3A) and the cloning process will do it all for the user.

Although specific embodiments have been illustrated and described, it will be appreciated by those skilled in the art that various modifications may be made without departing from the scope of the present invention, which is intended to be limited solely by the appended claims.

What is claimed is:

1. A method for cloning a source drive to a target drive, comprising:
launching a cloning program in a host device;
obtaining an amount of partitions and a size of each said partition of the source drive;
adaptively determining a size of each corresponding partition in the target drive according to a size of the source drive and a size of the target drive;
rebooting the host device; and
copying contents of the source drive to the target drive.

2. The method of claim 1, wherein the source drive is a hard disk drive (HDD) and the host device is a computer.

3. The method of claim 1, wherein the target drive is a solid state drive (SSD), a Universal Serial Bus (USB) drive or a USB flash drive.

4. The method of claim 1, before obtaining the amount and the sizes of partitions, further comprising:
selecting a drive as the source drive and a drive as the target drive.

5. The method of claim 1, wherein the amount and the sizes of partitions of the source drive are obtained from a Master Boot Record (MBR).

6. The method of claim 5, wherein the MBR comprises a partition table that records a start address and an end address of each said partition.

7. The method of claim 1, wherein in the step of adaptively determining the size of each said corresponding partition in the target drive, at least one of the partitions of the target drive has a size greater than the corresponding partition of the source drive when the size of the target drive is greater than the size of the source drive.

8. The method of claim 1, in the step of adaptively determining the size of each said corresponding partition in the target drive, at least one of the partitions of the target drive has a size smaller than the corresponding partition of the source drive when the size of the target drive is smaller than the size of the source drive.

9. The method of claim 5, before rebooting the host device, further comprising:
providing a modified MBR for booting into the target drive according to the sizes of the adaptively determined partitions of the target drive.

10. The method of claim 1, wherein in the step of rebooting the host device, the host is rebooted into an environment compliant with the target drive.

11. The method of claim 1, after copying the contents of the source drive to the target drive, further comprising:
shutting down the host drive.

12. The method of claim 1, wherein said adaptively determining the size of each corresponding partition in the target drive according to the size of the source drive and the size of the target drive is performed without user intervention.

13. A cloning system, comprising:
a target drive; and
a source drive disposed in a host device, which comprises a cloning program capable of being launched to clone the source drive to the target drive by copying contents of the source drive to the target drive;
wherein the source drive has a plurality of partitions and the target drive has a plurality of partitions corresponding to the partitions of the source drive;
wherein a size of at least one corresponding partition in the target drive is adaptively determined according to a size of the source drive and a size of the target drive.

14. The system of claim 13, wherein the target drive is a solid state drive (SSD), a Universal Serial Bus (USB) drive or a USB flash drive.

15. The system of claim 13, wherein the source drive comprises a Master Boot Record (MBR) that provides an amount of the partitions and a size of each said partition of the source drive.

16. The system of claim 15, wherein the MBR comprises a partition table that records a start address and an end address of each said partition.

17. The system of claim 13, wherein at least one of the partitions of the target drive is adaptively determined to have a size greater than the corresponding partition of the source drive when the size of the target drive is greater than the size of the source drive.

18. The system of claim 13, wherein at least one of the partitions of the target drive is adaptively determined to have a size smaller than the corresponding partition of the source drive when the size of the target drive is smaller than the size of the source drive.

19. The system of claim 13, before copying the contents of the source drive to the target drive, wherein the host device is rebooted.

20. The system of claim 13, wherein the size of each corresponding partition in the target drive is adaptively determined according to the size of the source drive and the size of the target drive without user intervention.
